(19) United States
(12) Patent Application Publication
(10) Pub. No.: US 2006/0254269 A1
(43) Pub. Date: Nov. 16, 2006

(54) Power regulating device

(76) Inventors: Karl-Heinz Blum, Obertalheim (DE); Harald Ludescher, Waldachtal-Salzstetten (DE); Wolfgang Kauss, Francheville (FR)

Correspondence Address: SCULLY, SCOTT, MURPHY & PRESSER, 400 GARDEN CITY PLAZA, SUITE 300, GARDEN CITY, NY, 11530, US

(21) Appl. No.: 10/571,201

(22) PCT Filed: Aug. 30, 2004
(86) PCT No.: PCT/EP04/09643

§ 371 Date: Mar. 7, 2006

(30) Foreign Application Priority Data
Sep. 8, 2003 (DE) 103 41 331.6

(51) Int. Cl. F16D 31/02

(52) U.S. Cl. 60/445

(57) ABSTRACT

The invention relates to a power control unit for a hydrostatic piston engine, the volumetric flow of which can be varied by a control unit (5). An operating pressure prevailing in the control unit (5) is controlled by a power regulating valve (9), which is connected to the control unit (5) by a feeder pipe (12). A non-return valve (15) and a throttle point (14) arranged parallel thereto are provided in the feeder pipe (12).

The invention relates to a power control unit for a hydrostatic piston engine.

For controlling the power in the case of a hydrostatic piston engine, it is known from DE 100 01 826 C1 that a power regulating valve, by which an operating pressure prevailing in an operating pressure chamber is regulated, is fitted in a recess formed on a housing of a hydrostatic piston engine. At the same time, the operating pressure chamber is arranged within a control unit, which is located in an axial extension of the power regulating valve. Channels, which open out into the operating pressure chamber are formed on the end face of the power regulating valve. Due to the working action of the actuating piston, the operating pressure chamber undergoes a variation in volume. A volumetric flow develops through the channels, which connect the operating pressure chamber with the power regulating valve due to this variation in volume.

The actuating piston is impinged with a spring force, which works towards a smaller volume of the operating pressure chamber. To relieve the operating pressure chamber, in the corresponding condition controlled by the power regulating valve the operating pressure chamber is connected to a tank of the hydrostatic piston engine. In this case a throttle point, by which the working action of the hydrostatic piston engine resulting from the spring loading of the actuating piston is prevented from being too fast, is provided in the pipe, which connects the power regulating valve to the tank. In order to reach a high regulating speed in the opposite adjustment direction, restriction is not provided in the inlet to the power regulating valve or in the connection between the operating pressure chamber and the power regulating valve.

A disadvantage with the known power control unit is that the volumetric flow is only restricted late in the way of the compressed fluid to the tank, whereby for example as the result of leakage from the power regulating valve and from any other existing pressure or volume regulating valves, a residual pressure build upstream of the throttle occurs, which negatively affects the control behaviour of the power control unit.

It is the object of the invention to create a power control unit for a hydrostatic piston engine wherein appropriate restriction in both adjustment directions takes place, without the power variation being affected by a residual pressure build up.

The object is achieved through the power control unit in accordance with the invention with the features of claim 1.

In the case of the power control unit in accordance with the invention a throttle point and a non-return valve arranged parallel thereto are provided in a feeder pipe, which connects an operating pressure chamber of the control unit with an outlet port of a power regulating valve. When the operating pressure chamber is relieved the non-return valve closes, so that the volumetric flow is restricted by the throttle point and thus the adjustment speed is reduced. Because of the non-return valve arranged in parallel, the flow cross section additionally released by the non-return valve can be used in the opposite direction, that is to say when the operating pressure chamber is pressurized, so that restriction of the volumetric flow does not arise, as a result of which high adjustment speeds are reached accordingly.

By locating the throttle point between the outlet of the power regulating valve and the operating pressure chamber, the working action of the actuating piston can be restricted without residual pressure build up being produced by the throttle point, which affects the control behaviour.

The sub-claims concern advantageous refinements of the power control unit in accordance with the invention.

In particular, it is advantageous if the power control unit is designed so that an increasing operating pressure adjusts the hydraulic pump towards less volumetric flow and if the non-return valve is arranged so that it opens towards the control unit. With such an arrangement it is ensured that with a rapid increase of pressure in the hydraulic system the hydraulic pump can be quickly adjusted towards a narrower pivot angle, so that damage to the system can be prevented.

Further, it is advantageous if the throttle point and the non-return valve are designed as a combined throttle non-return valve, which comprises a throttle pin able to move between two stops. With such a compact component part, integration in a housing of a hydraulic pump is possible by fitting the combined throttle non-return valve in a corresponding recess on the piston engine. It is particularly advantageous to design the throttle pin in such a way that the throttle point is located between the throttle pin and a stop. Thus, both the reduced cross section of the throttle point and the additional larger cross section which likewise can be adjusted so as to be slightly restricting, in the opposite direction can be defined by a single component part, that is to say the throttle pin.

Practical operation is therefore particularly unproblematic if the throttle point, which is located between the one stop and the throttle pin, is formed by flat zones, which are provided on a substantially circular cross section of the throttle pin. The rotationally symmetrical basic shape of the throttle pin at the same time not only facilitates production of the throttle pin, but also ensures with the likewise rotationally symmetrical stop, constant quality of the throttling and closing-behaviour.

Embodiments of the power control unit in accordance with the invention are illustrated in the drawing and described in detail on the basis of the following description.

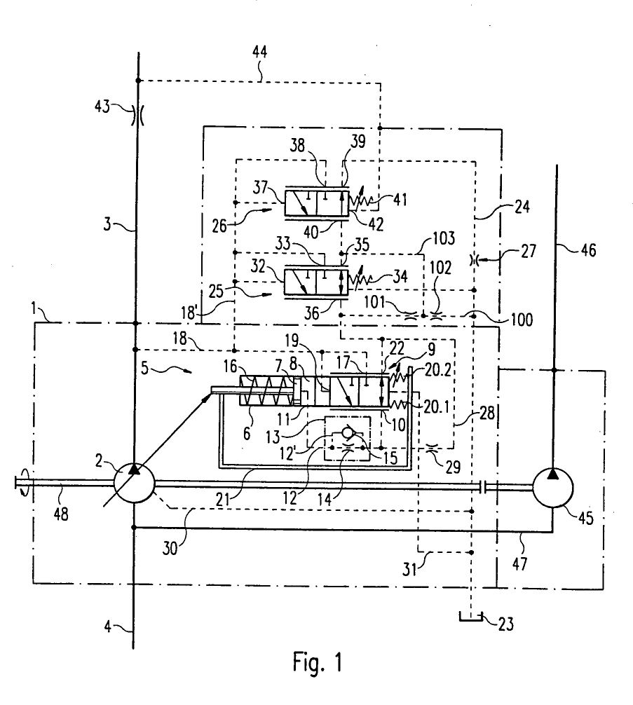

FIG. 1 shows a hydraulic circuit diagram for a power control unit in accordance with the invention,

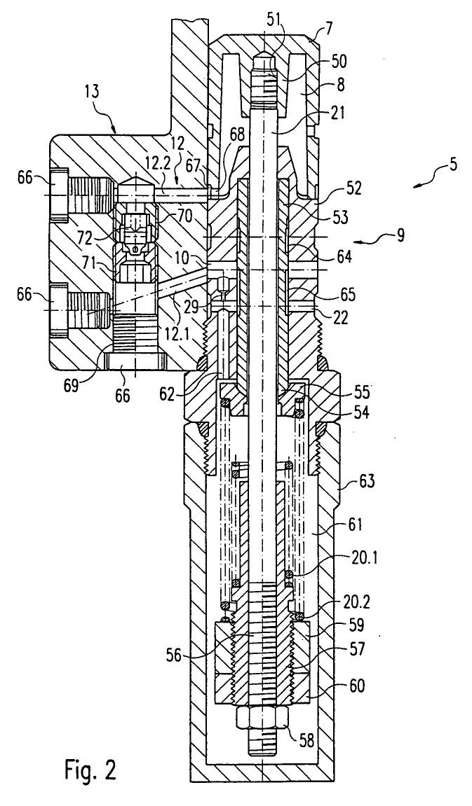

FIG. 2 shows a first embodiment of a power control unit in accordance with the invention,

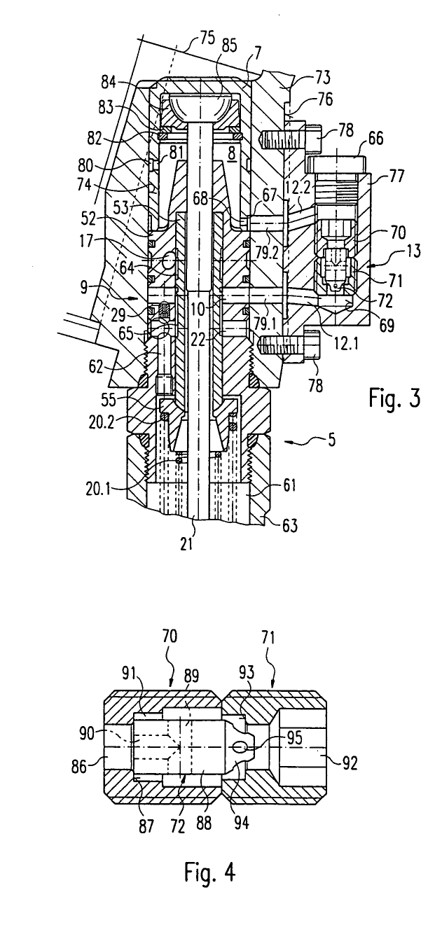

FIG. 3 shows a cutout section of a second embodiment of a power control unit in accordance with the invention,

FIG. 4 shows a partial section through a combined throttle non-return valve and

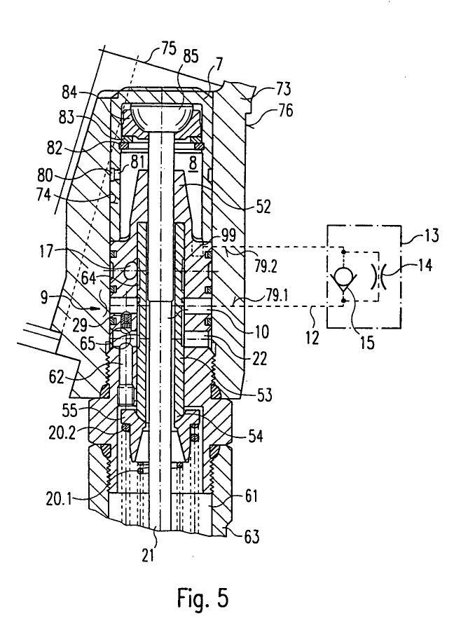

FIG. 5 shows a schematic representation of an arrangement in accordance with the invention of a non-return valve and a throttle point in the case of an integrated power regulating valve.

In FIG. 1, a hydraulic circuit diagram of a power control unit 5 in accordance with the invention is illustrated. The power control unit 5 is arranged in a hydraulic pump unit 1. The hydraulic pump unit 1 comprises a hydraulic pump 2, that pumps a compressed fluid, which it sucks from a second working pipe 4, into a first working pipe 3. To adjust the quantity of compressed fluid displaced by the hydraulic pump 2, a power control unit 5 is connected to an actuating unit of the hydraulic pump 2. The angle of a swash plate of an axial piston machine is adjusted by the actuating unit of the hydraulic pump 2 for example.

The power control unit 5 comprises an actuating cylinder 6, in which an actuating piston 7 is arranged, whose one actuating piston face is impinged in an operating pressure chamber 8 with the force of an operating pressure. To adjust the operating pressure prevailing in the operating pressure chamber 8 the power control unit 5 has a power regulating valve 9. An outlet port 10 of the power regulating valve 9 is connected by a feeder pipe 12 to an operating pressure chamber port 11 of the actuating cylinder 6.

A combined throttle non-return valve 13, which consists of a throttle point 14 located in the feeder pipe 12 and a non-return valve 15 located in a bypass 12′ arranged parallel thereto, is provided in the feeder pipe 12.

In order to ensure a defined position of the hydraulic pump 2 in the non-pressurized state, the actuating piston 7 is impinged by a reset spring 16 with a force, which acts against the operating pressure prevailing in the operating pressure chamber 8 on the actuating piston 7. In order to facilitate starting from the state of rest, the hydraulic pump 2 is swung out towards maximum volumetric flow from this position.

The power regulating valve 9 is designed as 3/2-way valve, which is infinitely variable between its two end positions. The power regulating valve 9 additionally to the outlet port 10 has an inlet port 17, which is connected by a delivery pressure pipe 18 to the first working pipe 3. The pressure in the first working pipe 3 produced by the hydraulic pump 2 is transmitted via the delivery pressure pipe 18 to the inlet port 17, which in a first end position of the power regulating valve 9 is connected to the outlet port 10. In this first end position the operating pressure chamber 8 is pressurized from the first working pipe 3 with the delivery pressure prevailing in the first working pipe 3.

The compressed fluid sucked from the first working pipe 3 via the delivery pressure pipe 18 is taken via the feeder pipe 12 to the operating pressure chamber 8, whereby the non-return valve 15 in the combined throttle non-return valve 13 opens and therefore an essentially unrestricted connection is made between the power regulating valve 9 and the operating pressure chamber 8 via the bypass 12′. The delivery pressure pipe 18 leads to the one delivery pressure gauge inlet 19, on which the power regulating valve 9 is impinged with a force, so that it is moved towards its first end position, which causes the operating pressure chamber 8 to become pressurized. The increase of the operating pressure in the operating pressure chamber 8 causes the actuating piston 7 in FIG. 1 to move to the left, whereby such a movement corresponds to a reduction of the pivot angle of the hydraulic pump 2 and thus of the set volumetric flow of the hydraulic pump 2.

The position of the valve piston located in the power regulating valve 9 is not only determined by the pressure lying on the delivery pressure gauge inlet 19, but also by a force, which is produced by a first compression spring 20.1 as well as a second, preferably variable compression spring 20.2 working in the opposite direction. The first and second compression springs 20.21.2 are supported on the one hand against the valve piston of the power regulating valve 9 and on the other hand against a couple bar 21, so that the force countering the delivery pressure on the valve piston of the power regulating valve 9 increases when the pivot angle is adjusted to become narrower and thus the power regulating valve 9 moves towards its second end position.

The power regulating valve 9 is therefore currently in an equilibrium position, which is determined by the pressure acting on the delivery pressure gauge inlet 19 as well as by the force of the first compression spring 20.1 and the second compression spring 20.2 working in the opposite direction, whereby the force of the compression springs 20.1 and 20.2 working in the opposite direction depends on the set volumetric flow of the hydraulic pump 2. The first compression spring 20.1 and the second compression spring 20.1¹ at the same time serve to match the control curve of the power regulating valve 9 through two vectors with a power hyperbola, for which purpose in the wide pivot angle range first only the force of one of the springs acts on the power regulating valve 9.
¹Translator's note: This is the number in the German original, but it should be 20.2.

If due to the rising operating pressure in the operating pressure chamber 8 the volumetric flow of the hydraulic pump 2 becomes less through the action of the actuating piston 7 and the movement associated therewith of the couple bar 21 the force on the valve piston of the power regulating valve 9 increases towards the second end position of the power regulating valve 9, the connection between the inlet port 17 and the outlet port 10 is increasingly interrupted and at the same time a connection is made between the outlet port 10 and a further port 22. Through this connection of the outlet port 10 with the further port 22 the feeder pipe 12 is connected to a tank 23. The operating pressure prevailing in the operating pressure chamber 8 is therefore released via the feeder pipe 12 into the tank 23 and the actuating piston 7 is moved by the reset spring 16 so that the hydraulic pump 2 is adjusted towards a wider pivot angle.

In this second end position of the power regulating valve 9 only a restricted flow is possible through the combined throttle non-return valve 13, since the non-return valve 15 closes due to the pressure differential. The operating pressure chamber 8 is only relieved by means of the throttle point 14, with the cross section of which the regulating speed of the actuating piston 7 can be varied. In order to maintain the non-return valve 15 in a defined position, which also occurs in the case of a low pressure differential between the operating pressure in the operating pressure chamber 8 and the pressure of the tank 23, the non-return valve 15 can also be impinged with a small spring force towards its closing position.

To connect the further port 22 of the power regulating valve 9 to the tank 23 a relief pipe 24 is provided, in which a pressure relief valve 25 as well as a flow control valve 26 are arranged. In the position illustrated in FIG. 1 of the pressure relief valve 25 and the flow control valve 26, which in each case present an end position of the corresponding valve, the two valves form a section of the relief pipe 24, through which fluid can flow without restriction.

For controlled restriction, an additional throttle 27 can be arranged in the relief pipe 24, the cross section of which in comparison to the known prior art can be implemented substantially larger, so that as a result of the throttle 27 a residual pressure build up in the section lying upstream of the throttle 27 is prevented. Reaction of the restriction through the throttle 27 on the control behaviour of the power regulating valve 9 is thereby prevented. If necessary, the throttle 27 can also be dispensed with entirely.

The outlet port 10 and the further port 22 of the power regulating valve 9 are additionally connected to the internal, unrestricted connection in the second end position of the power regulating valve 9 outside the power regulating valve 9 via a bypass 28, in which a second throttle 29 is arranged.

The outlet port 36 of the pressure relief valve 25 is connected via a second bypass 100, in which a third throttle 101 and a fourth throttle 102 are arranged in series, to the relief pipe 24 downstream of the throttle 27 arranged therein. A branch pipe 103, the other end of which opens out into a section of the relief pipe 24 lying between the further port 35 of the pressure relief valve 25 and the outlet port 40 of the flow control valve 26, branches off from the second bypass 100 between the third throttle 101 and the fourth throttle 102. Any leakage from the power regulating valve 9 is drained away via a leakage pipe 31 into the tank 23.

The control range of the power regulating valve 9 is limited by the pressure relief valve 25 towards too greatly rising pressure in the first working pipe 23. For this purpose, the pressure relief valve 25 has a delivery pressure gauge inlet 32, which equally as an inlet port 33 of the pressure relief valve 25, is connected via the delivery pressure pipe 18 and a delivery pressure pipe section 18′ branching off therefrom to the first working pipe 3. Below a limit which may be pre-set by an adjusting spring 34, the pressure relief valve 25 is in the end position shown and connects the further connection port 35 of the pressure relief valve 25 to the outlet port 36 of the pressure relief valve 25.

Against the force of the adjusting spring 34, the delivery pressure prevailing in the first working pipe 3 impinges on the delivery pressure gauge inlet 32 of the pressure relief valve 25. If this pressure exceeds a certain limit, the pressure relief valve 25 is adjusted towards its second end position, in which the inlet port 33 of the pressure relief valve 25 is connected to the outlet port 36 of the pressure relief valve 25. Therefore the further port 22 of the power regulating valve 9 is impinged with the delivery pressure so that the operating pressure chamber 8 is prevented from being relieved by the rising counter-pressure. The operating pressure chamber 8 is pressurized via the pressure relief valve 25 and therefore the hydraulic pump 2 is adjusted towards less volumetric flow and thus a further pressure rise in the first working pipe 3 is prevented.

If therefore due to the power adjustment through the power regulating valve 9 the operating pressure chamber 8 is relieved and the hydraulic pump 2 is adjusted towards a wider pivot angle, a rise of the pressure above a certain limit is prevented by the pressure relief valve 25, since the operating pressure prevailing in the operating pressure chamber 8 is increased via the pressure relief valve 25. Therefore above a certain limit of the delivery pressure in the first working pipe 3 the control is overridden by the power regulating valve 9 through the pressure relief valve 25.

Depending on the volume displaced in the first working pipe 3 the power regulating valve 9 can also be overridden by the flow control valve 26. For this purpose, the delivery pressure of the first working pipe 3 fed via the delivery pressure pipe section 18′ also lies on a delivery pressure gauge inlet 37 of the flow control valve 26 and on an inlet port 38 of the flow control valve 26. In addition to the force of a flow adjusting spring 41 on an operating pressure gauge inlet 42, an operating pressure obtained downstream of a flow throttle 43 from the first working pipe 3 acts against the hydrostatic pressure, which lies on the delivery pressure gauge inlet 37 of the flow control valve 26. For this purpose, downstream of the flow throttle 43 an operating pressure inlet 44 branches off from the first working pipe 3.

The force acting on the valve piston of the flow control valve 26 is dependent on the force of the variable flow adjusting spring 41, with which the start of regulating the flow control valve 26 is adjusted, and on the pressure differential in the first working pipe 3 upstream and/or downstream of the flow throttle 43.

If this pressure differential exceeds the limit preset by the flow adjusting spring 41, the valve piston of the flow control valve 26 is moved towards its second end position, in which the inlet port 38 of the flow control valve 26 is connected to the outlet port 40 of the flow control valve 26. Corresponding to the overriding action already described of the power regulating valve 9 through the pressure relief valve 25, if the flow control valve 26 is adjusted towards its second end position, the operating pressure chamber 8 of the control unit 5 is also prevented from being relieved, since the connection to the tank 23 is interrupted and instead of which the further port 22 of the power regulating valve 9 is connected to the inlet port 38 of the flow control valve 26.

Therefore the power adjustment by the power regulating valve 9 is also overridden when a certain limit of the volumetric flow in the first working pipe 3 is exceeded, since the operating pressure chamber 8 is pressurized with the pressure prevailing in the first working pipe 3. At the same time the operating pressure in the operating pressure chamber 8 is increased relatively quickly if the power regulating valve 9 is overridden, since the non-return valve 15 is opened by the inverted pressure differential.

Both if the pressure in the first working pipe 3 rises critically or if the volumetric flow displaced in the first working pipe 3 increases, the hydraulic pump 2 is adjusted toward less volumetric flow. Such critical operating situations can arise for example if a consumer is blocked, which leads to an increase of pressure, or if a leak develops downstream of the flow throttle 43.

When starting the system from the state of rest the hydraulic system is pressurized by an auxiliary pump 45 via a feeder 46, whereby delivery takes place for example into the first working pipe 3 via a valve system (not illustrated). In the embodiment illustrated in FIG. 1 the suction side of the auxiliary pump 45 is connected via a suction pipe 47 to the second working pipe 4. The auxiliary pump 45 can for example be implemented as a gear pump, which together with the hydraulic pump 2 is driven via a multi-part drive shaft 48.

FIG. 2 illustrates a constructive embodiment of a control unit 5. The control unit 5 is designed in this case so that it can be fitted as a cartridge in a corresponding recess of the housing of a piston engine. The actuating piston 7 is mounted slidingly in this recess of the housing. The actuating piston 7 exhibits a cup-shaped geometry, in the interior of which the operating pressure chamber 8 is formed.

Furthermore an extension 50, wherein a threaded orifice 51 is arranged, into which the couple bar 21 is screwed, is formed inside the cup-shaped geometry of the actuating piston 7. The couple bar 21 extends through a valve case 52 and a valve piston 53, which cooperate as power regulating valve 9. On the end turned away from the actuating piston 7 the valve piston 53 exhibits a dome-shaped curvature 54, on which a first spring bearing 55 lies. On the first spring bearing 55 a contact face for the first compression spring 20.1 and the second compression spring 20.2 are formed in each case. The couple bar 21 also extending through the first spring bearing 55 on its end turned away from the actuating piston 7 exhibits a thread 56, onto which a second spring bearing 57 is screwed. The second spring bearing 57 is secured with a lock nut 58 on the couple bar 21 and forms a contact face as well as a guide for the first compression spring 20.1.

Along its outer circumference an external thread is arranged on the second spring bearing 57 onto which a third spring bearing 59 is screwed, against which the second compression spring 20.2 is supported. In order also to prevent the third spring bearing 59 from rotating, the third spring bearing 59 is secured with a further lock nut 60. By rotating the second and/or third spring bearing 57 and/or 59 the distance to the first spring bearing 55 and therefore the control behaviour is adjusted by changing the spring force of the power regulating valve 9.

The spring bearings 55, 57 and 59 as well as the first compression spring 20.1 and the second compression spring 20.2 are arranged in a spring chamber 61, which is formed in a spring housing 63, which is sealingly screwed with an O-ring onto the valve case 52. The spring chamber 61 is connected via an equilibrium channel 62 to the further port 22 of the power regulating valve 9. The equilibrium channel 62 is formed as a bore in the valve case 52.

The valve piston 53 exhibits an all-round first groove 64 and an all-round second groove 65. If the valve piston 53 is in its position corresponding to the second end position of the power regulating valve 9, the further port 22 is connected through the second groove 65 to the outlet port 10. As the result of the pressure prevailing in the first groove 64 a force is exerted in the axial direction on the valve piston 53. In order to produce this force the opposite lying peripheries of the first groove 64 are dimensioned differently. The different dimension of the faces is achieved through a gradation of the valve piston 53 and the valve case 52.

If the pressure in the first groove 64 rises, the axial force pushes the valve piston 53 against the force of the first and second compression springs 20.1 and 20.2. As a result of the movement of the valve piston 53 the second groove 65 is pushed so far that the connection between the further port 22 and the outlet port 10 is increasingly interrupted. At the same time, the first groove 64 comes to overlap the outlet port 10, so that the inlet port 17, not visible in FIG. 2, is increasingly connected with the outlet port 10.

The channel, which forms the outlet port 10 in the valve case 52, is connected to the channel, which forms the further port 22 in the valve case 52, through an axial bore, the narrowest cross section of which forms the bypass throttle 29.

The control unit 5 is preferably fitted as a subassembly in a housing of a piston engine. In addition, a first connection channel 12.1 and a second connection channel 12.2 are arranged in the housing of the piston engine. The first connection channel 12.1 and the second connection channel 12.2 are sealed on the outside of the housing by a plug 66 in each case.

The first connection channel 12.1 opens out at the side of the control unit 5 on the housing so that it communicates with the outlet port 10. The second connection channel 12.2 opens out so that a connection is made with the operating pressure chamber 8. In order to make a connection with the operating pressure chamber 8 for this purpose several connection openings 68 can be arranged for example on the actuating piston 7, distributed over the circumference of the actuating piston 7. Preferably, in this region the actuating piston 7 is provided on its outer circumstance with an all-round groove 67.

The first connection channel 12.1 and the second connection channel 12.2 are completed by a seat opening 69 to the feeder pipe 12, in which the combined throttle non-return valve 13 is arranged. The seat opening 69 for example can be formed as pocket hole in the housing of the piston engine, whereby an inner thread is formed at least over a part of the length of the pocket hole. A first housing insert part 70 and a second housing insert part 71 are screwed into the seat opening 69. Initially, the first housing insert part 70 and the throttle pin 72 are inserted into the seat opening 69. Subsequently, the second housing insert part 71 is screwed into the seat opening 69, before the seat opening 69 is likewise sealed with a plug 66.

The first housing insert part 70 and the second housing insert part 71 together with the throttle pin 72 arranged therein form the combined throttle non-return valve 13, which is described in more detail with reference to FIG. 4.

The throttle pin 72 exhibits a conical part, which cooperates with a stop to form a throttle point and can freely move between two stops.

Depending on the pressure differential the throttle pin 72 is maintained in contact with one or the other stop. Therefore a restricting cross section or however a larger cross section either between the throttle pin 72 and the one stop is released, which makes an unrestricted or only slightly restricted connection between the first connection channel 12.1 and the second connection channel 12.2.

A second embodiment is shown in FIG. 3. Here it is evident that in a housing 73 of the piston engine a valve seat 74 in the form of a recess is arranged in the housing 73, into which the control unit 5 is inserted with a part of its linear extension. The actuating piston 7 of the control unit 5 due to its working action operates a swash plate 75, with which the volumetric flow of the hydrostatic piston engine is adjusted. On the outside of the housing 73 a mounting face 76 is formed, on which a housing 77 of the throttle non-return valve 13 is mounted.

In the embodiment illustrated in FIG. 3 the housing 77 of the throttle non-return valve 13 is mounted by means of screws 78 to the housing 73 of the axial piston engine. A first housing channel 79.1 and a second housing channel 79.2 which connect the valve seat 74 to the first connection channel 12.1 and the second connection channel 12.2, which for their part are provided in the housing 77 of the non-return valve 13 are accommodated in the housing 73. The first and second housing channel 79.1 and 79.2 together with the first connection channel 12.1 and the second connection channel 12.2 as well as the seat opening 69 connecting the two connection channels 12.1 and 12.2 therefore form the connection channel 12. The inlet port 17 of the power regulating valve 9, actually concealed in the profile, is illustrated in FIG. 3.

The constituent parts of the second embodiment in FIG. 3, substantially identical with the constituent parts of the embodiment from FIG. 2 already described, are identified with the same reference symbols. To avoid unnecessary repetition, these are not described again.

In order to keep the friction losses arising to a minimum during a working action of the actuating piston 7 in the valve seat 74, a lubrication channel 80, which is connected to the operating pressure chamber 8 via at least one lubrication bore 81 is arranged on the piston shaft of the actuating piston 7 on its outer circumference. The operating pressure prevailing in the operating pressure chamber 8 ensures minimum leakage flow in the gap formed between the actuating piston 7 and the valve seat 74, which serves to lubricate the actuating piston 7 arranged slidingly in the valve seat 74.

To axially fix the couple bar 21 on the actuating piston 7 a snap ring 82 is inserted in the actuating piston 7, through which just as a disk 83 lying thereon the couple bar 21 extends. A supporting body 84, which exhibits a cavity corresponding to a spherical head 85 is supported on the disk 83. The spherical head 85 is connected to the couple bar 21 and is supported on the side of the actuating piston 7 turned away from the groove of the supporting body 84, so that both traction and thrust forces can be transmitted between the couple bar 21 and the actuating piston 7.

The operating mode of the combined throttle non-return valve 13 will be explained on the basis of the components defining the function, which are illustrated in FIG. 4 without the housing to accommodate them. A first recess 86, which is implemented with gradation is arranged in the first housing insert part 70. The recess 86 is preferably rotationally symmetric and extends through the housing insert part 70. As a result of the at least one radial extension of the recess 86 a first stop 87 is formed, whereon a cylindrical part 88 of the throttle pin 72 lies, whenever the throttle non-return valve 13 is in its open position.

The cylindrical part 88 has a diameter, which is greater than the radially non-extended part of the recess 86, but smaller than the radially extended part of the recess 86, so that a gap 91 arises between the lateral face of the cylindrical part 88 of the throttle pin 72 and the first housing insert part 70. To make an unrestricted connection a cross hole 89 and a linear hole 90 connected therewith drilled from the front of the cylindrical part 88 are provided in the cylindrical part 88. As a result of the cross hole 89 and the linear hole 90 the radially non-extended part of the recess 86 is connected to the gap 91 and therefore a non-restricted connection is made between the connection channels 12.1 and 12.2, also when the throttle pin 72 lies against the first stop 87.

At the side of the first housing insert part 70, on which the radially extended section of the recess 86 opens out, a second recess 92 joins recess 86, which is formed in the second housing insert part 71, again preferably rotationally symmetrical, and extends through this. The second recess 92 also exhibits at least one radial step, which forms a second stop 93, pointing in the opposite direction to the first stop 87. In the direction of the second stop 93 a conical part 94 joins the cylindrical part 88 of the throttle pin 72.

The diameter of the radially non-extended section of the second recess 92 is so dimensioned that the throttle pin 72 with the conical part 94 can partly telescope into the radially non-extended section of the second recess 92, such that the lateral face of the truncated cone comes into contact with the inner circumferential edge of the second stop 93. In the embodiment illustrated in FIG. 4 several flat zones 95 are formed on the circumference of the conical part 94. Owing to the flat zones 95, the throttle pin 72 cannot sit sealingly on the second stop 93, but forms a throttle point, the cross section of which is preferably defined by the geometry of the flat zones 95. The gap 91 formed between the throttle pin 72 and first housing insert part 70 is continued in the radially extended section of the second housing insert part 71.

To form a restricting cross section, instead of the flat zones 95 on the conical part 94 of the throttle pin 72, notches can also be provided on the second stop 93 for example. The throttle pin 72 after the second housing insert part 71 has been screwed off the housing, not shown in FIG. 4, can be replaced by another throttle pin. Therefore if different flat zones are used on the throttle pins, the throttle point formed accordingly can be individually adjusted. In addition it is possible by defining a limiting cross section for example of the linear hole 90 to achieve a restricting effect when the non-return valve 15 is open and therefore to adjust not only the pivoting of the piston engine towards a wider pivot angle, but also to adjust its pivoting back to narrower pivot angles.

FIG. 5 once again shows a schematic illustration of the embodiment from FIG. 3, in the case of which however a channel is provided in the valve case 52 as connection point for the feeder pipe 12. The connection to the operating pressure chamber 8 can therefore be simply formed as bore 99 in the valve case 52 running in an axial direction. To form the feeder pipe 12 a first housing channel 79.1 and a second housing channel 79.2, which connect the valve seat 74 to the outside of the housing 73 are again provided in the housing 73 of the piston engine.

1. A power control unit for a hydrostatic piston engine, the volumetric flow of which can be varied by a control unit, wherein an operating pressure prevailing in the control unit can be adjusted by a power regulating valve, which is connected to the control unit via a feeder pipe, characterized in that wherein a non-return valve and a throttle point arranged parallel thereto are provided in the feeder pipe.

2. The power control unit according to claim 1, characterised in that wherein the hydrostatic piston engine whenever the operating pressure increases, is adjusted towards less volumetric flow and the non-return valve opens towards the control unit.

3. The power control unit according to claim 1, wherein the operating pressure can be adjusted dependent on the volumetric flow of the hydrostatic piston engine by the power regulating valve.

4. The power control unit according to claim 1, wherein the non-return valve and the throttle point are implemented as a combined throttle non-return valve, which comprises a throttle pin able to move between two stops.

5. The power control unit according to claim 4, wherein at least one stop, whenever the throttle pin is in contact, forms with the throttle pin a throttle point.

6. The power control unit according to claim 5, wherein the throttle pin within a region cooperating with the stop to form a throttle point exhibits a substantially circular cross section, which in order to form the throttle cross section has at least one flat zone on its circumference.

7. The power control unit according to claim 4, wherein the throttle pin of the combined throttle non-return valve can be replaced and other throttle cross sections can be produced by exchanging the throttle pin.

8. The power control unit according to claim 4, wherein the throttle pin is pre-biased with a spring in the closing direction of the non-return valve.

9. The power control unit according to claim 1, wherein the power regulating valve can be inserted at least partially into a recess of a housing of a hydrostatic piston engine, whereby channels are provided in the housing, which form a part of the feeder pipe.

10. The power control unit according to claim 9, wherein the channels run from the recess of the hydrostatic piston engine to a second recess, which is provided to seat the combined throttle non-return valve.

11. The power control unit according to claim 9, wherein the channels open out at their end turned away from the recess outside on the housing and a flat zone is formed in the combined throttle non-return valve.
